(19) United States
(12) Patent Application Publication
(10) Pub. No.: US 2007/0292105 A1
(43) Pub. Date: Dec. 20, 2007

(54) Method and apparatus for recording and reproducing audio signals and video signals

(75) Inventor: Hiroyuki Kamio, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/812,464

(22) Filed: Jun. 19, 2007

(30) Foreign Application Priority Data
Jun. 20, 2006 (JP) 2006-170442

(51) Int. Cl. H04N 5/93

(52) U.S. Cl. 386/52

(57) ABSTRACT

According to one embodiment of a recording apparatus of the invention includes a detection unit which detects that video and audio signals recorded to be capable of being transferred or moved to a first recording medium configured to record a first standard exist on a second recording medium configured to record a second standard, from specific information of a data structure, and a data transfer control unit which transfers or moves the video and audio signals recorded to be capable of being transferred or moved to the first recording medium configured to record the first standard, to a first recording medium without re-encoding, when the detection unit detects that the video and audio signals recorded to be capable of being transferred or moved to the first recording medium exist.

### CROSS-REFERENCE TO RELATED APPLICATIONS

This application is based upon and claims the benefit of priority from Japanese Patent Application No. 2006-170442, filed Jun. 20, 2006, the entire contents of which are incorporated herein by reference.

### BACKGROUND

1. Field

One embodiment of the invention relates to a recording/reproducing apparatus capable of recording and reproducing audio and video data. In particular, the invention relates to a recording/reproducing apparatus and an audio/video signal recording method capable of recording and reproducing audio signals and video signals of desired standards on recording media of different standards.

2. Description of the Related Art

A recording/reproducing apparatus (a digital video recorder) for recording digital data on a DVD standard optical disc has been widely used as a recording apparatus for recording audio and video data. Accompanying the start of a digital broadcasting, an HD DVD standard optical disc has been developed for recording high-definition video signals, while ensuring compatibility with a DVD standard optical disc. A recording apparatus (HD DVD recorder) is already available on the market.

For example, Japanese Patent Application Publication (KOKAI) No. 2004-357275, which proposes a video recording apparatus that generates data for an HDD (Hard Disc Drive) in a DVD-HDVR format in addition to DVD-VR format data for a DVD disc, and records the data on the HDD or a DVD disc.

However, the multi-format proposed in the above Publication No. 2004-357275 requires simultaneously generating and previously recording parameters necessary for various formats, which increases the size of the recording data. Besides, the proposed apparatus does not provide an optimum format conformable to standards of recording media. Further, whether a HD DVD standard optical disc is included in a recordable medium is not described.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a recording/reproducing apparatus (HD DVD recorder) according to an embodiment of the invention;

FIG. 2 is an exemplary diagram showing an example of a file structure of the recording/reproducing apparatus shown in FIG. 1, according to an embodiment of the invention;

FIG. 3 is an exemplary diagram showing examples of a data structure of the recording/reproducing apparatus shown in FIG. 1, according to an embodiment of the invention;

FIG. 4 is an exemplary diagram showing examples of management information (HDVR_MG) of the recording/reproducing apparatus shown in FIG. 1, according to an embodiment of the invention;

FIG. 5 is an exemplary diagram showing an example of M_AVFIT (Movie AV File Information Table Information) included in the management information (HDVR_MG/M_AVFIT) shown in FIG. 4, according to an embodiment of the invention;

FIG. 6 is an exemplary diagram showing examples of information stored in M_VOB_STI (Movie VOB Stream Information) included in the management information (HDVR_MG/M_AVFIT) shown in FIG. 4, according to an embodiment of the invention;

FIG. 7 is an exemplary diagram showing examples of information stored in video attribute information (V_ATR included in M_VOB_STI shown in FIG. 6, according to an embodiment of the invention;

FIG. 8 is an exemplary diagram showing examples of information stored in first audio attribute information (A_ATR0) included in M_VOB_STI shown in FIG. 6, according to an embodiment of the invention;

FIG. 9 is an exemplary diagram showing examples of information stored in second audio attribute information (A_ATR1) included in M_VOB_STI shown in FIG. 6, according to an embodiment of the invention;

FIG. 10 is an exemplary diagram showing an example of a pack structure by units of data (EVOBU) constituting a VR object shown in FIG. 3, according to an embodiment of the invention;

FIG. 11 is an exemplary diagram showing examples of information included in a pack header shown in FIG. 10, according to an embodiment of the invention;

FIG. 12 is an exemplary diagram showing examples of information included in a header of a video packet existing as a part of pack (MPEG1, MPEG2 or MPEG4-AVC) shown in FIG. 10, according to an embodiment of the invention;

FIG. 13 is an exemplary diagram showing examples of information included in a header of a video packet existing as a part of pack shown in FIG. 10, according to an embodiment of the invention;

FIG. 14 is an exemplary diagram showing an example of a structure of an RDI pack (RDI_PCK) placed at the beginning of a data unit (EVOBU) constituting a VR object shown in (a) of FIG. 3 to (h) of FIG. 3, according to an embodiment of the invention;

FIG. 15 is an exemplary diagram showing examples of information included in a system header of the RDI pack shown in FIG. 14, according to an embodiment of the invention;

FIG. 16 is an exemplary flowchart of a method of recording and reproducing audio and video data capable of recording data in an optimum format according to the standard of a recording medium set (prepared by the user) in a disc drive unit of the recording/playback apparatus shown in FIG. 1, according to an embodiment of the invention;

FIG. 17 is an exemplary diagram showing an example of description of “sub_stream_id” in the contents of a packet header of a linear PCM, according to an embodiment of the invention;

FIG. 18 is an exemplary diagram showing an example of a structure of RDI pack (RDI_PCK and GCI_PCK) placed at the beginning of a data unit (EVOBU) constituting a HDVR object shown in FIG. 3, according to an embodiment of the invention;

FIG. 19 is an exemplary diagram explaining P-STD_buffer_size in the contents of a packet header of a linear PCM, according to an embodiment of the invention; and

FIG. 20 is an exemplary flowchart of a method of dubbing data recorded in an HD DVD video recording mode (hereinafter called a HDVR mode) or a DVD video recording mode (VR mode), on an inserted medium without re-encoding between HDVR (mode) and VR (mode), in the recording/reproducing apparatus capable of recording the HD DVD disc and DVD disk shown in FIG. 1.

### DETAILED DESCRIPTION

Various embodiments according to the invention will be described hereinafter with reference to the accompanying drawings. In general, according to one embodiment of the invention, a recording apparatus of the invention includes a detection unit which detects that video and audio signals recorded to be capable of being transferred or moved to a first recording medium configured to record a first standard exist on a second recording medium configured to record a second standard, from specific information of a data structure; and a data transfer control unit which transfers or moves the video and audio signals recorded to be capable of being transferred or moved to the first recording medium configured to record the first standard, to a first recording medium without re-encoding, when the detection unit detects that the video and audio signals recorded to be capable of being transferred or moved to the first recording medium exist.

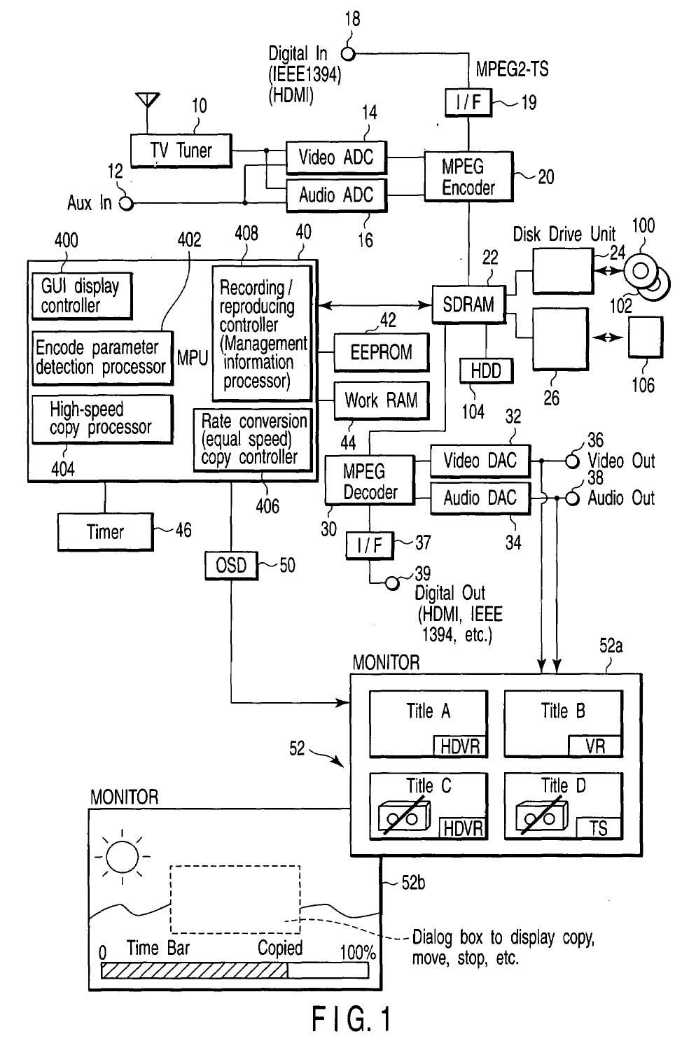

According to an embodiment, FIG. 1 shows an example of a video recording apparatus (digital recorder), to which an embodiment of the invention is applicable.

A digital recorder (video recording/reproducing apparatus) 1 shown in FIG. 1 has a TV tuner 10 capable of receiving satellite digital TV broadcasting provided through a broadcasting satellite or a communication satellite, and terrestrial digital/analog TV broadcasting provided by a terrestrial wave (space wave). The output from the tuner 10 is applied to a video channel analog-digital converter (Video AD) 14 and an audio (voice/music) channel analog-digital converter (Audio ADC) 16. An input signal from an external input terminal (Aux) 12 is also applied to the video ADC 14 and audio ADC 16.

A video stream digitized by the video ADC 14 and audio stream digitized by the audio ADC 16 are applied to an MPEG encoder 20. A digital stream from an external digital input terminal 18 (MPEG2-TS (TS: Transport Stream) is applied to an MPEG encoder 20 through an interface (I/F) 19 such as IEEE 1394 (or HDMI).

When a TV broadcasting signal supplied to the tuner 10 is a digital signal such as MPEG2-TS, the digital stream from the tuner is applied to the MPEG encoder 20 as it is. The MPEG encoder 20 encodes the input stream to MPEG2-PS or MPEG4-AV, other than outputting (passing through) the input MPEG-TS as it is.

The input stream is encoded to MPEG2-PS in the following cases:

(a) When encoding to MPEG2-PS (PS: Packetized Stream) based on the DVD-VR standard (Max. rate 10.08 Mbps, Max. resolution 720×480 or 720×576)

(b) When encoding to MPEG2-PS at a high rate based on the HD_DVD-VR standard (Max. rate 30.24 Mbps, Max. resolution 1920×1080)

(c) When encoding to MPEG2-PS at a low rate in the HD_DVD-VR standard (Max. rate 10.08 Mbps, Max. resolution 720×480 or 720×576).

The stream data encoded (or passed through) in the MPEG encoder 20 is once buffered in a high-speed memory, for example, SDRAM (Synchronous Dynamic Random Access Memory) 22.

In the SDRAM 22, the stream is rewritten (format change) in the following cases:

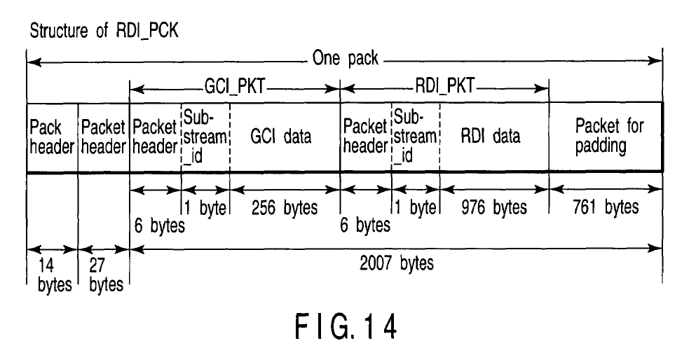

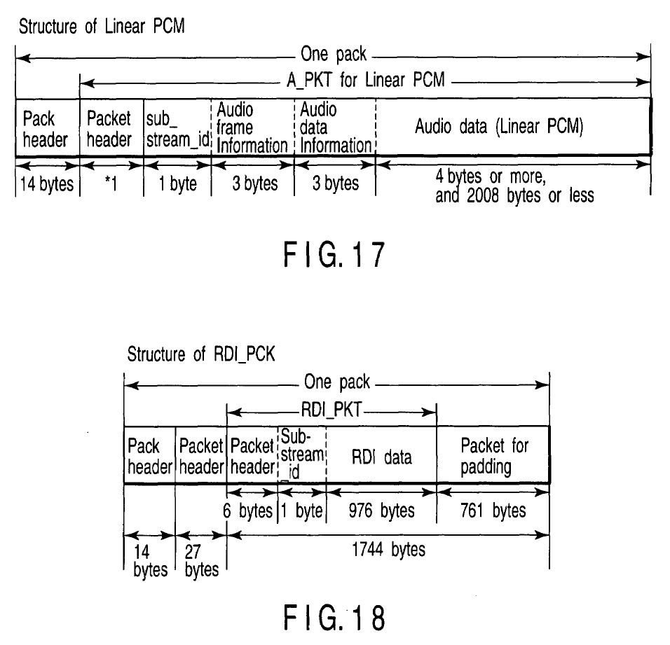

(1) When Audio is Liner PCM, the value of sub_stream_id of Audio Packet of a data structure (explained later with reference to FIG. 14 and FIG. 17) is rewritten

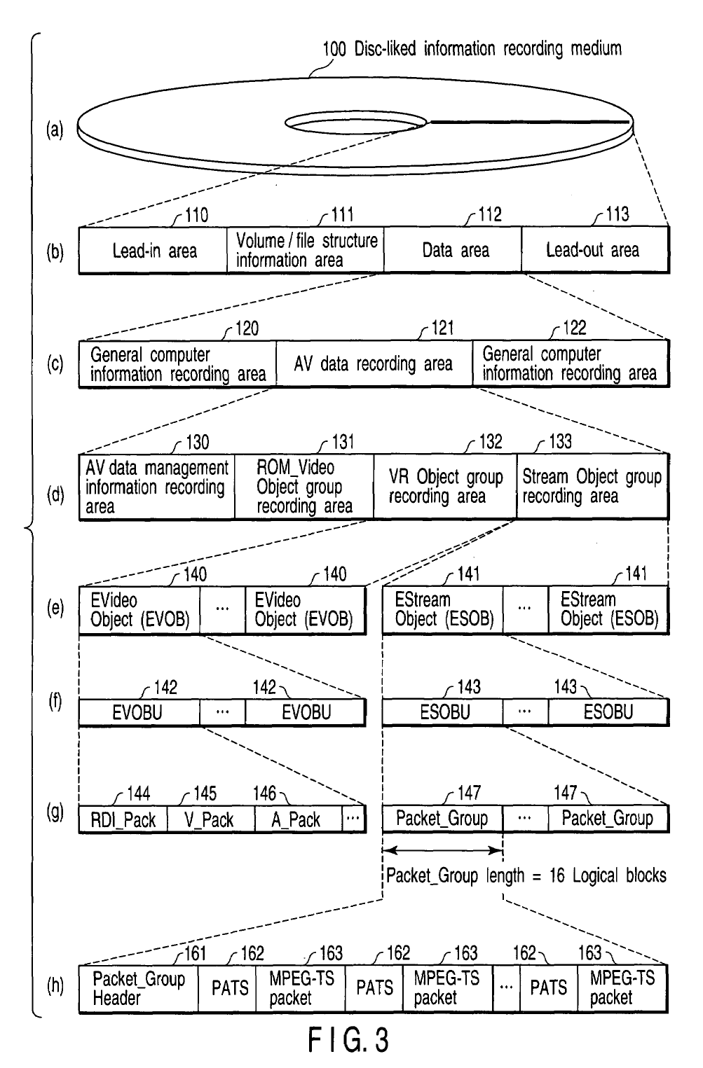

(2) The description contents (format) of RDI-PKT of a data structure/parameters (explained later with reference to FIG. 3(a) to FIG. 3(h) to FIG. 15) is rewritten (a simple RDI-PKT and a RDI-PKT with GCI-PKT are exchanged)

(3) The data encrypted by CPRM (the standard of copy management when recording is allowed only once in a DVD-standard optical disc) is decrypted, and re-encrypted to AACS (the standard of copy management when recording is allowed in a HD DVD-standard optical disc), or reverse decryption and re-encryption.

The stream data buffered and processed in the SDRAM 22 is transferred to an HDD 104, a disc drive unit 24 or a memory slot 26 at a predetermined timing according to the contents. The HDD 104 includes an HDD (Hard Disc Drive of 1 TB (1000 GB) capacity, for example).

The disc drive unit 24 is a circular recording medium, which is capable of recording data (stream) on an optical disc 100 of the HD DVD standard (15 GB in play-only, 20 GB in recording) and an optical disc 102 of the DVD standard (4.5 GB), and capable of reproducing data (stream) already recorded. As the disc drive unit 24, any one of drives is incorporated: two independent drives (for DVD and HD DVD) including a rotation driving channel, a HD DVD/DVD compatible drive having individual optical heads for using a blue laser (e.g. wavelength λ=405 nm) and a red laser (e.g. wavelength λ=655 nm), common in a rotation driving channel, or an HD DVD/DVD compatible drive having dual-wavelength optics used by switching blue and red lasers, common in a rotation driving channel and an optical head mechanism.

Irrespective of the type of drive incorporated, as a recording medium, an optical disc of +R (recording is allowed only once at an increased recording speed) and an optical disc of +RW (reproducible in an apparatus designed for a -R disc) are also usable, in addition to an optical disc of -R (recording is allowed only once)/-RW (rewritable)/RAM (rewritable) standards, in each of blue laser optical disc 100 and red laser optical disc 102. Each optical disc is available as a single-side two-layer type or double-side type. Data can be recorded and reproduced on/from these optical discs. In the future, it is possible to use a large-capacity optical disc using holograms. In the memory slot 26, a card memory 106 of a capacity of 2 GB, for example, is inserted.

As described above, the disc drive unit 24 is capable of recording and reproducing based on the HD DVD-VR and DVD-VR standards. When the DVD-standard optical disc 102 is prepared as a recording medium, even if data is encoded based on the HD DVD-VR standard, MPEG-PS data whose maximum rate and video attribute meet the DVD-VR standard can be recorded (copied or moved) at an equal speed or at a higher speed on a desired type disc of the DVD-VR standard (single-side one-layer DVD-R/RW/RAM, single-side two-layer DVD-R, or double-side one-layer DVD-RAM).

As a concrete example, when the data recorded in the HDD 104 is MPEG2-PS of NTSC video with a maximum rate of 10.08 Mbps, even the data encoded based on the HD_DVD-VR standard can be copied/dubbed on the DVD-VR standard disc 102 at a high speed. Of course, MPEG2-PS data encoded based on the HD DVD-VR standard can be copied or dubbed on the HD DVD-VR standard disc 100.

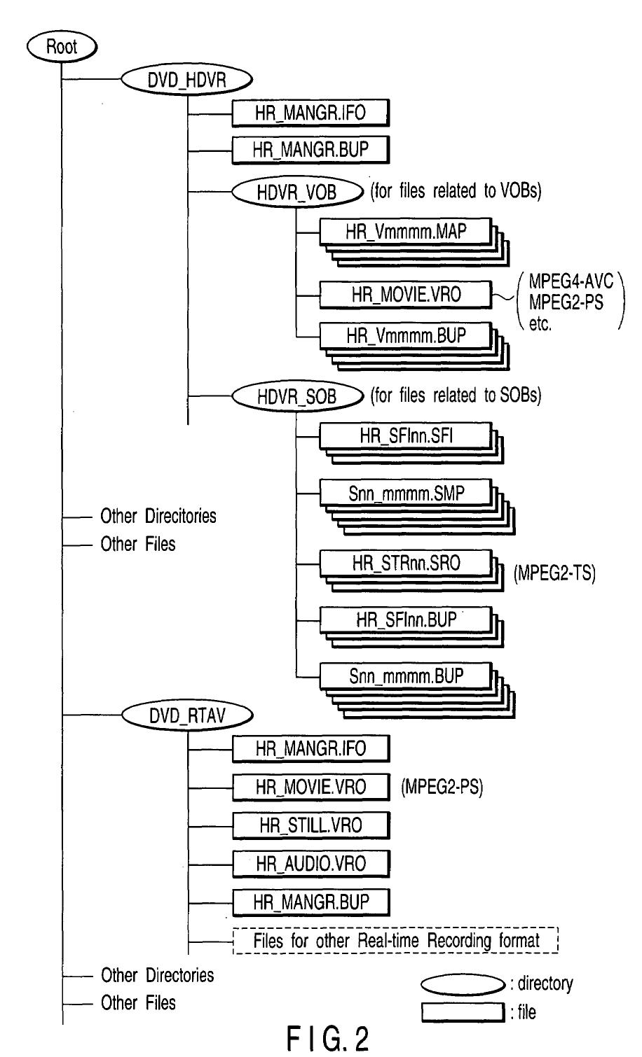

This is realized by the structure of data recorded in the HDD 104, as explained later by using FIG. 2, in which a DVD_HDVR directory includes HR_MANAGER. IFO, which is a management information file of the HD DVD-VR format, a HDVR_VOB directory including a VRO file, which is an object file of analog video input (an EVOB file with a maximum rate allowed up to 30.24 Mbps), and a HDVR_SOB directory including a SRO file (ESOB file) applicable to digital broadcasting, and a DVD_RTAV directory under the same root directory as the DVD_HDVR directory includes VR_MANAGER. IFO and a VRO file that is an object file of analog video input (a conventional DVD-VR VOB file with a maximum rate suppressed to 10.08 Mbps). (In the file structure of this embodiment, HDVR MPEG2-TS data files, HDVR MPEG2-PS data files and VR MPEG2-PS data files are managed under the same root directory.)

The stream data reproduced from the optical disc 100 or 102, HD (in HDD) or card memory 106 through the disc drive unit 24 and/or HDD 104 or memory slot 26 is transferred to the MPEG decoder 30 through the SDRAM 22. The MPEG decoder 30 can decode the stream data into MPEG2-TS, MPEG2-PS or MPEG4-AVC. The MPEG decoder 30 can decode VC-1 defined by the HD DVD-VR standard.

The video data (MPEG2-TS or MPEG2-PS) decoded by the MPEG decoder 30 is converted into an analog video signal with standard or high definition picture quality by the video channel digital-analog converter (Video DAC) 32, and supplied to the video output terminal (Video Out) 36. The video output terminal 36 is connected to a monitor 52 to display the video data (on the monitor 52).

The audio data decoded by the MPEG decoder 30 is converted into an analog audio signal by the audio (voice/music) channel digital-analog converter (Audio DAC) 34, and supplied to an audio (voice) output terminal (Audio Out) 38. The audio output terminal 38 is connected to a speaker (incorporated in the monitor 52, or provided independently) to play back the audio data (voice or music).

When the data supplied to the MPEG decoder 30 is MPEG2-TS, the data is supplied to a digital output terminal (Digital Out) 39 as it is through an interface 37 such as IEEE 1394 (or HDMI).

The recording/reproducing apparatus (HD DVD recorder) shown in FIG. 1 is controlled by a MPU 40. The MPU 40 is supplied with an EEPROM 42 for storing firmware and various control parameters, a work RAM 44, and a timer 46. The firmware of MPU 40 includes a GUI display controller 400 for providing a graphical user interface (GUI), an encoded parameter detector/processor 402, a high-speed copy (dubbing) processor 404, a rate conversion copy (equal-speed copy/dubbing) controller 406, and a recording/reproducing controller (management information processor) 408. Needless to say, the MPU 40 controls transfer of audio and video signals among the SDRAM 22, HDD 124, disc drive unit 24 and memory slot 26.

The processing result of the GUI display controller 400 is supplied to the monitor 52 through an on-screen display controller (OSD) 50. On a title thumbnail display screen 52a and a dialog box display screen 52b upon copying, the processing result by the OSD 50 is displayed over the video output supplied from the video output terminal 36, explained before.

As for the HDD 104, either one super-large capacity HDD (e.g. 1 TB) or two or more large-capacity HDDs (e.g. 500 GB+500 GB) can be used. Concerning the way of using the recording area of the HDD 104, the recording area may be logically divided into two or more partitions, or may be specified for a specific purpose for each physical HDD.

In the former case, a first 400 GB partition in 1 TB may be assigned for recording MPEG2-TS (TS title) of digital high-definition broadcasting, a second 400 GB partition may be assigned for recording MPEG4-AVC (HDVR title) of digital high-definition broadcasting, and a third 200 GB partition may be assigned for recording MPEG2-PS (VR title) of analog or digital broadcasting or external input.

In the latter case, a first 400 GB HDD may be assigned for recording MPEG2-TS (TS title), a second 400 GB HDD may be assigned for recording MPEG4-AVC (HDVR title), and a third 200 GB HDD may be assigned for recording MPEG2-PS (VR title).

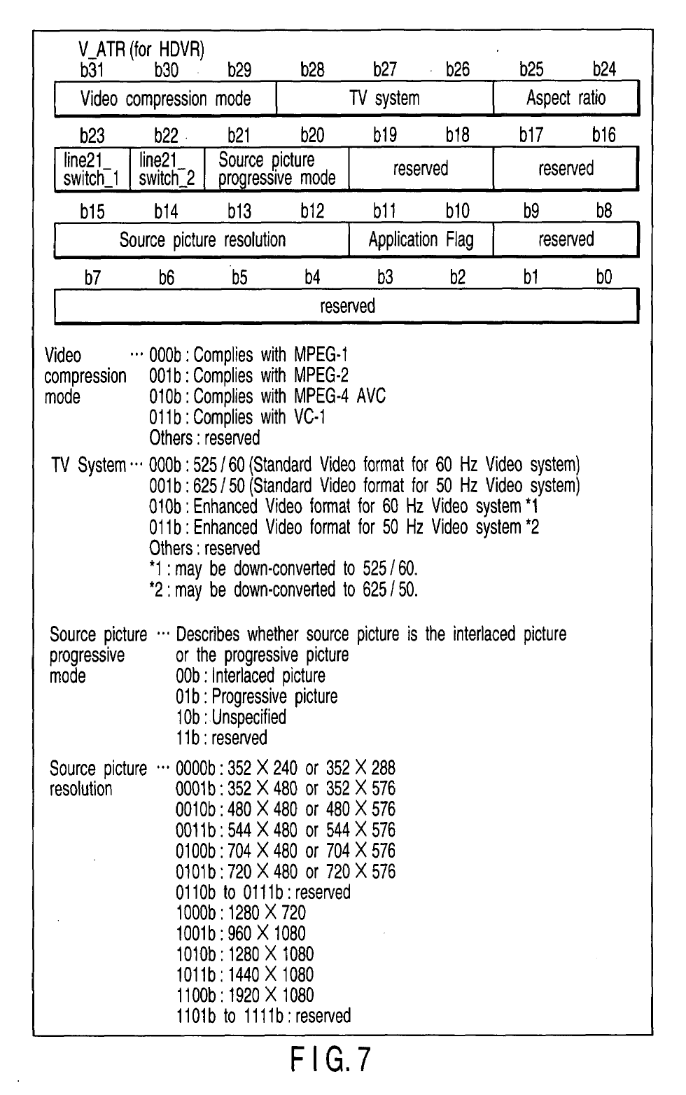

In this embodiment, the VR title includes MPEG2-PS records of the HD DVD standard with a maximum rate suppressed to 10.08 Mbps, in addition to MPEG2-PS records of the current DVD-VR, as described in FIG. 2. For example, whether stream data of one VR title is MPEG2-PS of DVD-VR or MPEG2-PS of HD DVD with a maximum rate suppressed to 10.08 Mbps can be discriminated by detecting (reading) whether the contents of program_mux_rate in the description contents of the Pack header in the data structure shown in FIG. 1 are 10.08 Mbps or 30.24 Mbps, at the object data level. At the management information level, it can be discriminated by detecting (reading) whether the V_ATR in the data structure shown in FIG. 7 includes a resolution unlikely in the DVD-VR standard (e.g. 1280×1080), before starting reproduction of that title.

In other words, by giving (describing) 1280×1080 to the V_ATR in the data structure shown in FIG. 7 at the management information level so that MPEG2-PS of DVD-VR or MPEG2-PS of HD DVD with a maximum rate suppressed to 10.08 Mbps can be discriminated at the time of recording, records (data) are given discrimination information to be identified as records (data) in the HD DVD-VR mode at the time of reproducing. Similarly, by setting the contents of program_mux_rate in the description contents of the Pack header in the data structure shown in FIG. 11 to 30.24 Mbps, records (data) are given discrimination information to be identified as records (data) in the HD DVD-VR mode at the time of reproducing.

FIG. 2 is a diagram explaining the file structure according to one embodiment of the invention. As shown in FIG. 2, the DVD_HDVR directory includes HR_MANAGER. IFO, which is a management information file of the HD_DVD-VR format, a HDVR_VOB directory including a VRO file, which is an object file of analog video input (an EVOB file with a maximum rate allowed up to 30.24 Mbps), and a HDVR_SOB directory including a SRO file (ESOB file) applicable to digital broadcasting. A DVD_RTAV directory under the same root directory as the DVD_HDVR directory includes VR_MANAGER. IFO and a VRO file that is an object file of analog video input (a conventional DVD-VR VOB file with a maximum rate suppressed to 10.08 Mbps).

Namely, in the file structure of this embodiment, HDVR MPEG2-TS data file, HDVR MPEG2-PS data file and VR MPEG2-PS data file are managed under the same root directory. For example, assuming a shortcut file linked to HR_MOVIE. VRO a title thumbnail A/C, a shortcut file linked to VR_MOVIE. VRO a title thumbnail B, and a shortcut file linked to HR STRnn. SRO a title thumbnail D, these title thumbnails A to D can be displayed on the same menu screen (refer to the display example of the monitor screen 52a in FIG. 1). Therefore, the user can handle a different object (an object including MPEG2-PS and MPEG2-TS) in the menu under the same screen-operating environment.

In FIG. 3(a) to FIG. 3(h) shows data structures according to an embodiment of the invention. As a typical example of a recordable or rewritable information storage medium, there is a DVD disc 100 (single or multiple recording layer DVD±R, DVD±RW and DVD-RAM using a red laser with a wavelength of about 650 nm or a blue-purple or blue laser with a wavelength of 405 nm or less). As shown in FIG. 3(a) to FIG. 3(h), the disc 100 includes a lead-in area 110, volume/file structure information area 111 a volume/file structure information area 111 containing a file system, and a data area 112 for actually recording a data file and lead-out area 113. The file system is composed of information to identify a recorded file and a place to record that file.

The data area 112 includes areas 120 and 122 recorded by an ordinary computer, and an area 121 to record audio/video data (A/V data). The AV data recording area 121 includes an AV data management information area 130 having a video manager file (VMG or HDVR_MG) for managing AV data, a ROM_Video object group recording area 131 for recording a file of object data conformable to the DVD-Video (ROM Video) standard, a VR object group recording area 132 for recording a file (VRO file) of object data (ESOBS: Extended Video Object Set) conformable to the video recording (VR) standard, and a recording area 133 for recording a file (SRO file) of stream object data (ESOBS: Extended Stream Object Set) having an object corresponding to digital broadcasting. The recording standard for an SRO file is described as a stream recording (SR) standard as appropriate.

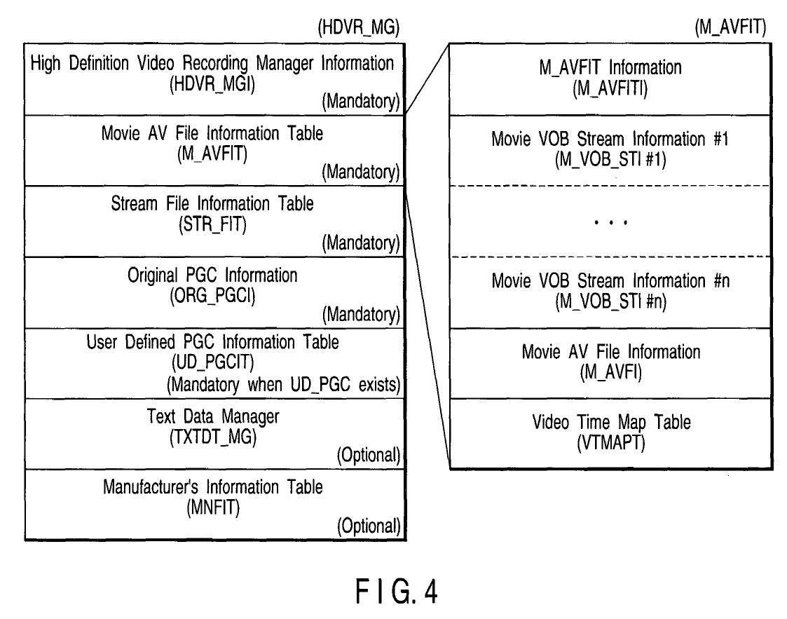

FIG. 4 is a diagram showing examples of management information (HDVR_MG) according to an embodiment of the invention. A HDVR MG file as management information includes a high-definition video recording manager (HDVR_MGI), a movie AV file information tale (M_AVFIT), a stream file information table (STR_FIT), an original program chain information (ORG_PGCIT), a text data manager (TXTDT_MG), and manufacturer information table (MNFIT), sequentially from the beginning as appropriate. An object (SRO file) of MPEG2-TS is managed by STR_FIT. An object (VRO file) of MPEG2-PS is managed by M_AVFIT.

The M_AVFIT includes movie AV file information table information (M_AVFIT), more than one movie video object stream information (M_VOB_STI#1 to M_VOB_STI#n), movie AV file information (M_AVFI), and a video time map table (VTMAPT), sequentially from the beginning as appropriate. Here, M_AVFIT in the conventional DVD-VR standard does not include VTMAPT. Therefore, even the same MPEG2-PS object can be discriminated whether it is of the conventional DVD-VR standard or HD DVD-VR standard (not at the object information level but the management information level), by checking whether M_AVFIT in such management information includes VTMAPT, or not.

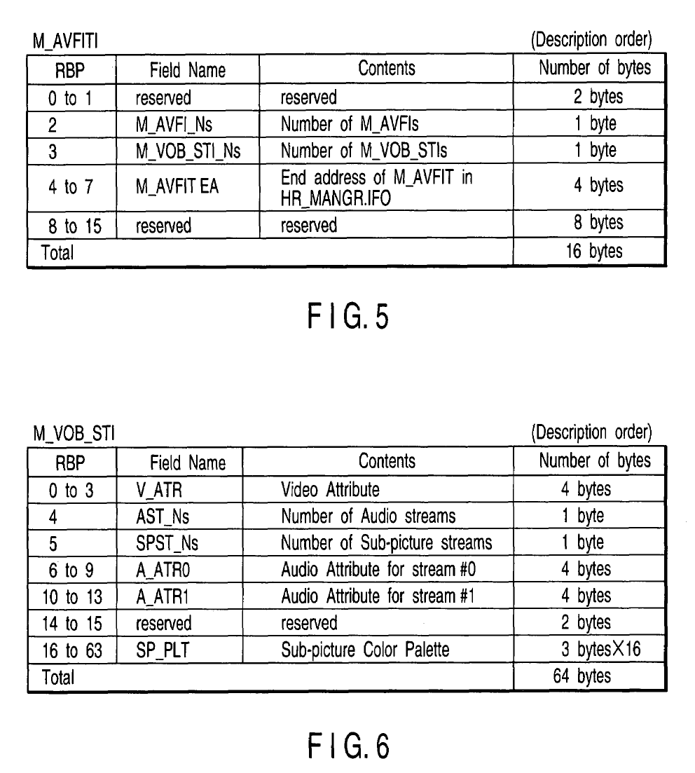

FIG. 5 is a diagram explaining information examples stored in M_AVFITI (Movie AV File Information Table Information) included in the management information (HDVR_MG/M_AVFIT) of FIG. 4. The M_AVFITI includes information (M_AVFI_Ns) indicating the number of existing M_AVFI, information (M_VOB_STI_Ns) indicating the number of existing M_VOB_STI, and end address information of M_AVFIT in HR_MANGR. IFO (shown in FIG. 2), is sequentially from the beginning as appropriate.

FIG. 6 is a diagram explaining information examples stored in M_VOB_STI (Movie VOB Stream Information) included in the management information (HDVR_MG/M_AVFIT). The M_VOB_STI includes information (AST_Ns) indicating the number of existing audio streams, information (SPST_Ns) indicating the number of existing sub-picture streams, audio attribute information (A_ATR0) of stream #0, audio attribute information (A_ATR1) of stream #1, and color pallet information (SP_PLT) of sub-pictures, sequentially from the beginning as appropriate.

FIG. 7 is a diagram explaining information examples stored in the video attribute information (V_ATR) included in M_VOB_STI of FIG. 6. These information examples include information not existing in the DVD-VR standard, but existing only in the HD DVD-VR standard. The V_ATR includes video compression mode information (Video compression mode), TV system information (TV system), aspect ratio information (Aspect ratio), line 21 switching information (line 21_switch_{—}1, line 21_switch_{—}2), source picture progressive mode information (Source picture progressive mode), source picture resolution information (Source picture resolution), and application flag information (Application Flag), sequentially from the position of b31 to the position of b0 as appropriate.

In the HD DVD-VR standard, Video compression mode can include information indicating MPEG4-AVC (010b) or VC-1 (011b). Since MPEG4-AVC and VC-1 are video compression modes not included in the DVD-VR standard, even the same object of MPEG2-PS can be discriminated whether that MPEG2-PS is of the conventional DVD-VR standard or HD DVD-VR standard (discriminated not at the object information level, but at the management information level), by checking whether the Video compression mode includes the information indicating MPEG4-AVC (010b) or VC-1 (011b).

In the HD DVD-VR standard, a TV system can include information indicating an extended video format for a 60 Hz video system, i.e., down-convertible to NTSC format (010b) or an extended video format for a 50 Hz video system, i.e., down-convertible to PAL format (011b). Since the extended video format for a 60 Hz video system and extended video format for a 50 Hz video system are TV systems not included in the DVD-VR standard, even the same object of MPEG2-PS can be discriminated as to whether it is of the conventional DVD-VR standard or HD DVD-VR standard (discriminated not at the object information level, but at the management information level), by checking whether the TV system includes the information indicating the extended video format for a 60 Hz or 50 Hz video system (010b or 011b).

Further, in the HD DVD-VR standard, a Source picture progressive mode (information indicating that Source picture is an interlace picture or a progressive picture ) can be included. Since the Source picture progressive mode is a mode not included in the DVD-VR standard, even the same object of MPEG2-PS can be discriminated as to whether it is of the conventional DVD-VR standard or HD DVD-VR standard (discriminated not at the object information level, but at the management information level), by checking whether it includes the information indicating Source picture progressive mode.

Further, in the HD DVD-VR standard, the Source picture resolution can include information indicating high definition or high resolution (1280×720 to 1920×1080) (1000b to 1100b). Since such high definition or high resolution (1280×720 to 1920×1080) is a resolution not included in the DVD-VR standard, even the same object of MPEG2-PS can be discriminated as to whether it is of the conventional DVD-VR standard or HD DVD-VR standard (discriminated not at the object information level, but at the management information level), by checking whether the Source picture resolution includes the information indicating high definition or high resolution.

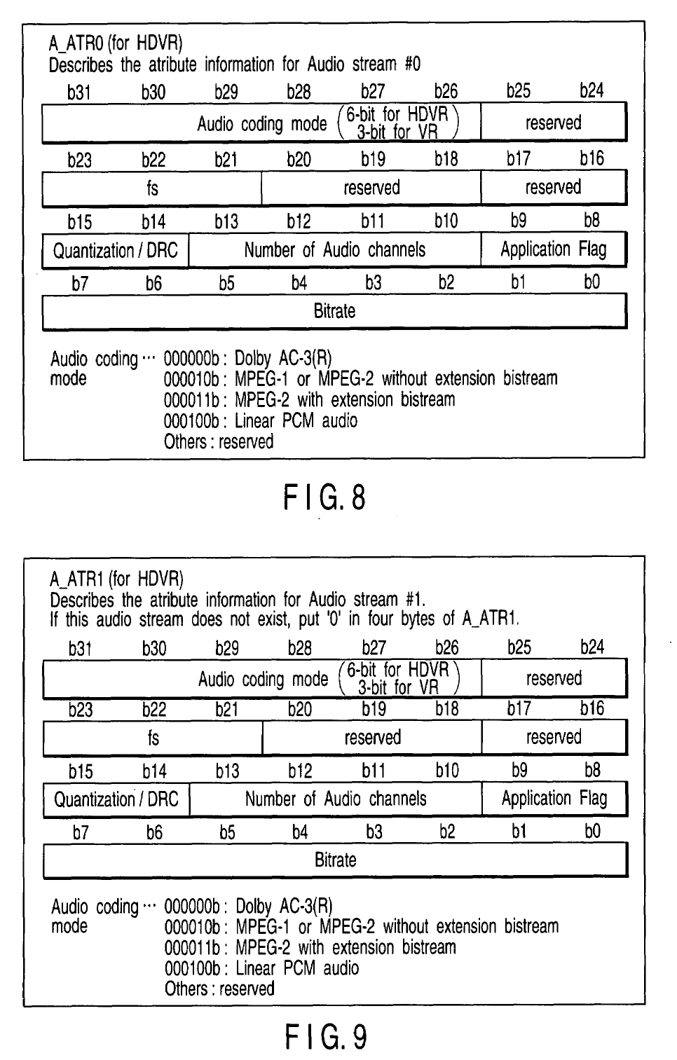

FIG. 8 is a diagram explaining information examples stored in a first audio attribute information (A_ATR0) included in M_VOB_STI of FIG. 6. These information examples include information not existing in the DVD-VR standard, but existing only in the HD DVD-VR standard. The A_ATR0 includes audio coding mode information (Audio coding mode), sampling frequency information (fs), quantization/dynamic range control information (Quantization/DRC), number of audio channels information (Number of Audio channels), application flag information (Application Flag), and bit rate information (bit rate), sequentially from the position of b31 to the position of b0 as appropriate. When the application flag is 00b, it indicates that the corresponding audio stream includes audio data of the channel mode defined by Number of audio channels. When the application flag is 01b, it indicates that the corresponding audio stream includes audio data of multi-channel mode, monaural mode, dual monaural mode or stereo mode.

In the HD DVD-VR standard, six bits are assigned to describe the Audio coding mode. In the DVD-VR standard, the Audio coding mode is described by three bits. Therefore, even the same object of MPEG2-PS can be discriminated as to whether it is of the conventional DVD-VR standard or HD DVD-VR standard (discriminated not at the object information level, but at the management information level), by checking the number of bits assigned to describe the Audio coding mode in A_ATR0.

FIG. 9 is a diagram explaining information examples stored in second audio attribute information (A_ATR1) included in M_VOB_STI of FIG. 6. These information examples include information not existing in the DVD-VR standard, but existing only in the HD DVD-VR standard. Like the A_ATR0, the A_ATR1 includes audio coding mode information (Audio coding mode), sampling frequency information (fs), quantization/dynamic range control information (Quantization/DRC), number of audio channels information (Number of Audio channels), application flag information (Application Flag), and bit rate information (bit rate), sequentially from the position of b31 to the position of b0 as appropriate.

In the HD DVD-VR standard, six bits are assigned to describe the Audio coding mode. In the DVD-VR standard, the Audio coding mode is described by three bits. Therefore, even the same object of MPEG2-PS can be discriminated as to whether it is of the conventional DVD-VR standard or HD DVD-VR standard (discriminated not at the object information level, but at the management information level), by checking the number of bits assigned to describe the Audio coding mode in A_ATR1.

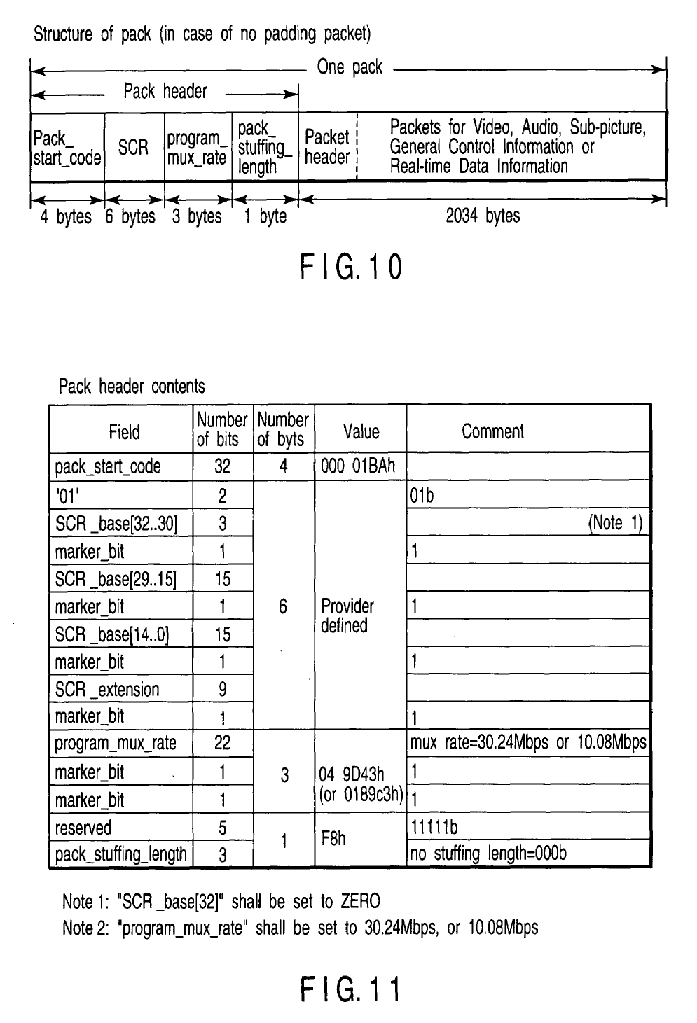

FIG. 10 is a diagram explaining an example of a pack structure by units of data (EVOBU) constituting a VR object shown in (a) of FIG. 3 to (h) of FIG. 3. For example, EVOBU in (f) of FIG. 3 includes various packs (video pack, audio pack, sub-picture pack, general control information pack, etc.) subsequently to the RDI pack at the beginning. The structure of each pack is as shown in FIG. 9, and includes program_mux_rate in its Pack header.

FIG. 11 is a diagram explaining information examples stored in the Pak header of FIG. 10. These information examples include information not existing in the DVD-VR standard, but existing only in the HD_DVD-VR standard (program_mux_rate including a high bit rate of 30.24 Mbps recognized in the HD DVD-VR standard). When MPEG2-PS is encoded at a rate lower than 10.08 Mbps under the HD DVD-VR standard, “0189C3” indicating 10.08 Mbps is described in program_mux_rate in the pack header including stream information of this MPEG2-PS.

When MPEG2-PS is encoded at a rate higher than 10.08 Mbps under the HD DVD-VR standard, the “049D43h” indicating 30.24 Mbps is described in program_mux_rate in the pack header including stream information of this MPEG2-PS. By the description contents of program_mux_rate, whether that MPEG2-PS is applicable to the DVD-VR standard in the HD DVD-VR standard (“0189C3” indicating program_mux_rate=10.08 Mbps) or conformable to the HD_DVD-VR standard (the “049D43h” indicating program_mux_rate=30.24 Mbps) can be discriminated (discriminated not at the object information level, but at the management information level).

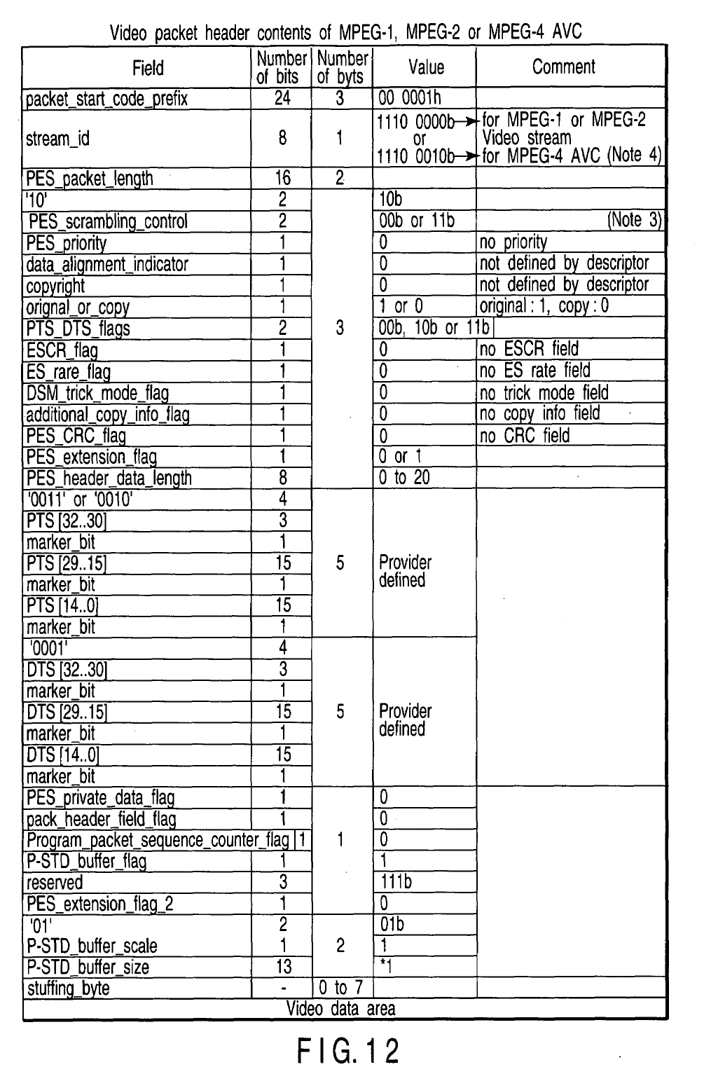

FIG. 12 is a diagram showing examples of information included in a header of video packet existing as a part of pack of FIG. 10 (MPEG1, MPEG2 or MPEG4-AVC). These information examples include information not existing in the DVD-VR standard, but existing only in the HD DVD-VR standard. Video packet headers of MPEG1, MPEG2 or MPEG4-AVC include information such as stream_id, PES_scrambling_control and P-STD_buffer_size.

In the HD DVD-VR standard, PES_scrambling_control includes information indicating whether the corresponding pack is an encrypted pack (Encrypted Pack) or not. Therefore, even the same object of MPEG2-PS can be discriminated as to whether it is conformable to the DVD-VR standard in the HD DVD-VR standard or of the HD DVD-VR standard, by checking whether it includes the information indicating whether the pack is encrypted pack, or not.

In the HD DVD-VR standard, information indicating whether MPEG4-AVC or not can be described in stream_id. Therefore, even the same object of MPEG2-PS can be discriminated as to whether it is conformable to the DVD-VR standard in the HD DVD-VR standard or of the HD DVD-VR standard, by checking whether the stream_id includes the description indicating MPEG4-AVC.

Further, in the HD DVD-VR standard, a buffer size (946176 bytes in standard, 1851392 bytes in expanded) used for MPEG4-AVC can be described in P-STD_buffer_size. Therefore, even the same object of MPEG2-PS can be discriminated as to whether it is conformable to the DVD-VR standard in the HD DVD-VR standard or of the HD DVD-VR standard, by checking whether P-STD_buffer_size includes the description indicating the buffer size for MPEG4-AVC, or not.

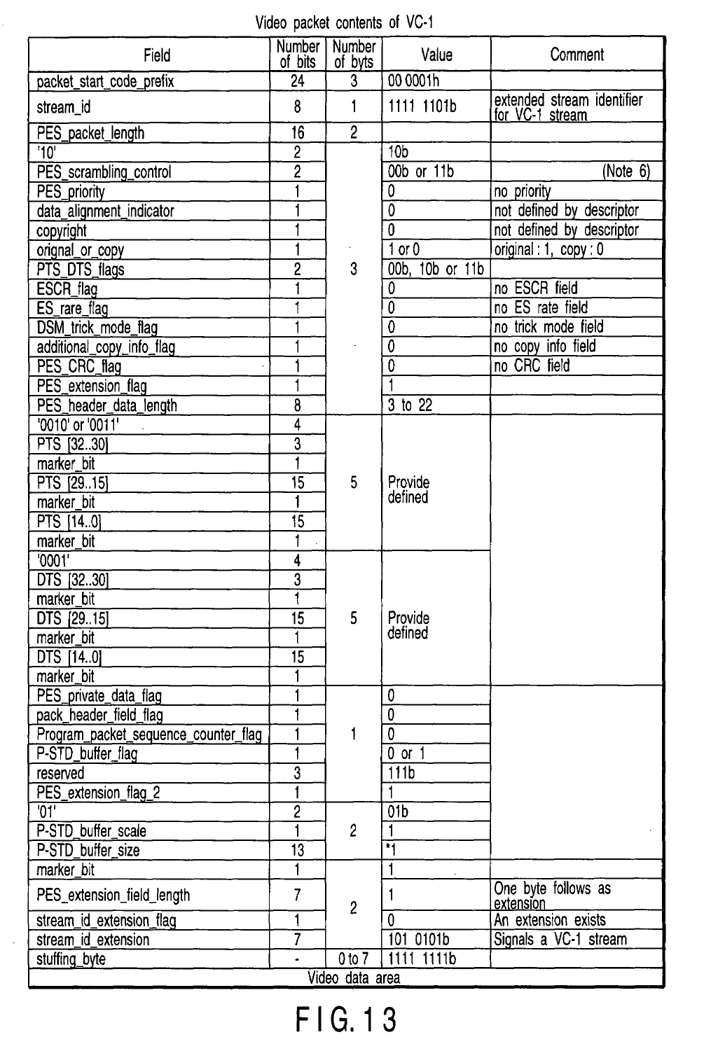

FIG. 13 is a diagram showing other examples (VC-1) of information included in a header of video packet existing as a part of the pack of FIG. 10. These information examples include information not existing in the DVD-VR standard, but existing only in the HD_DVD-VR standard. The video packet header of VC-1 includes information such as stream_id, PES_scrambling_control and P-STD_buffer_size.

In the HD DVD-VR standard, even in the case of VC-1, PES_scrambling_control includes information indicating whether the corresponding pack is an encrypted pack (Encrypted Pack) or not. Therefore, even the same object of MPEG2-PS can be discriminated as to whether it is conformable to the DVD-VR standard in the HD DVD-VR standard or of the HD DVD-VR standard, by checking whether it includes the information indicating whether the pack is an encrypted pack, or not.

In the HD DVD-VR standard, information indicating whether VC-1 or not can be described in stream_id. Therefore, even the same object of MPEG2-PS can be discriminated as to whether it is conformable to the DVD-VR standard in the HD DVD-VR standard or of the HD DVD-VR standard (discriminated not at the object information level, but at the management information level), by checking whether the stream_id includes the description indicating VC-1.

Further, in the HD DVD-VR standard, even in the case of VC-1, a buffer size (946176 bytes in standard, 1851392 bytes in expanded) used for VC-1 can be described in P-STD_buffer_size. Therefore, even the same object of MPEG2-PS can be discriminated as to whether it is conformable to the DVD-VR standard in the HD DVD-VR standard or of the HD DVD-VR standard (discriminated not at the object information level, but at the management information level), by checking whether P-STD_buffer_size includes the description indicating the buffer size for VC-1, or not.

FIG. 14 is a diagram showing an example of a structure of an RDI pack (RDI_PCK) placed at the beginning of a data unit (EVOBU) constituting a VR object in (a) of FIG. 3 to (h) of FIG. 3. For example, each EVOBU in (f) of FIG. 3 includes an RDI pack at the beginning. The RDI pack includes a pack header and a system header, General Control Information packet (GCI_PKT) and Real-time Data Information packet (RDI_PKT), and a padding packet at the end, as appropriate.

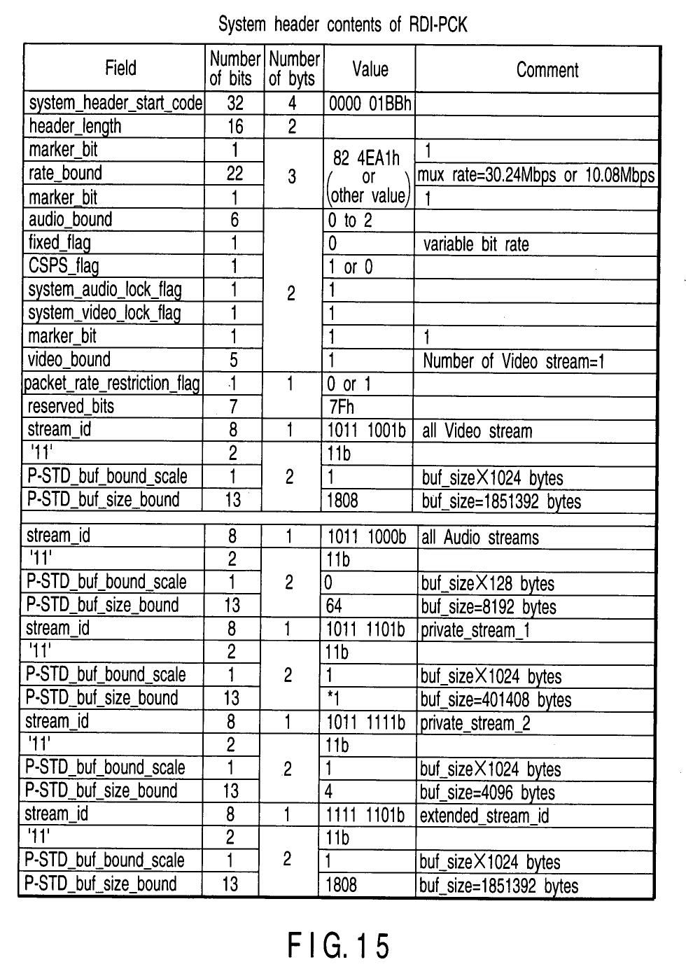

FIG. 15 is a diagram showing examples of information included in a system header of an RDI pack of FIG. 14. These information examples include information not existing in the DVD-VR standard, but existing only in the HD DVD-VR standard. The RDI pack includes rate_bound indicating one of mux_rate=30.24 Mbps as an upper limit in the HD DVD-VR standard, or mux_rate=10.08 Mbps applicable to the DVD-VR standard in the HD DVD-VR standard. By the description contents of the rate_bound, it is possible to discriminate whether MPEG2-PS is conformable to the DVD-VR standard in the HD DVD-VR standard, or of the HD DVD-VR standard can be discriminated (discriminated not at the object information level, but at the management information level).

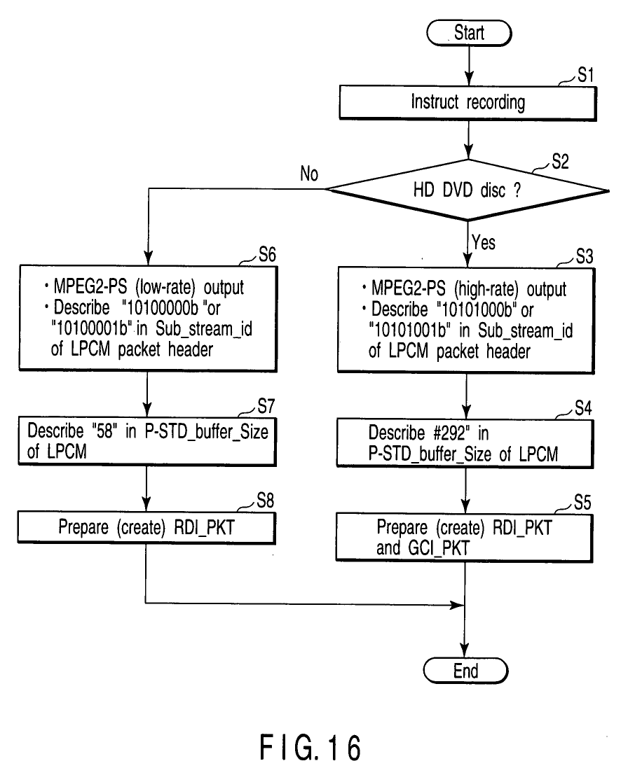

Next, an explanation will be given on an example of a method of recording pictures and music capable of recording data in an optimum format according to the standard of a recording medium set (prepared by the user) in a disc drive unit with reference to FIG. 16. Here, the recording/reproducing apparatus 1 shown in FIG. 1 is taken as an example. Explanation will be given on a method of recording without re-encoding between both formats of the DVD-VR standard format (DVD Video Recording Format) and HD DVD-VR format (HD DVD Video Recording Format), in other words, detecting a format conforming to a recording media, and conforming to that format, in a DVD recorder capable of recording and reproducing data in both formats.

When the user instructs recording on an optical disc, that is, the DVD-standard optical disc 100 or 102 set in the disc drive unit 24 through a not-shown remote controller (S1), the standard (type) of that optical disc and the conformable format are detected (S2).

When the standard of the optical disc detected in the step S2 is HD DVD (S2—YES), the MPEG encoder 20 outputs a high-rate encode output of MPEG2-PS in the HD DVD-VR mode according to (b) explained hereinbefore. In this time, “10101000b” or “10101001b” is described in sub_stream_id in the contents of the packet header of the linear PCM shown in FIG. 17, according to (1) explained hereinbefore (S3).

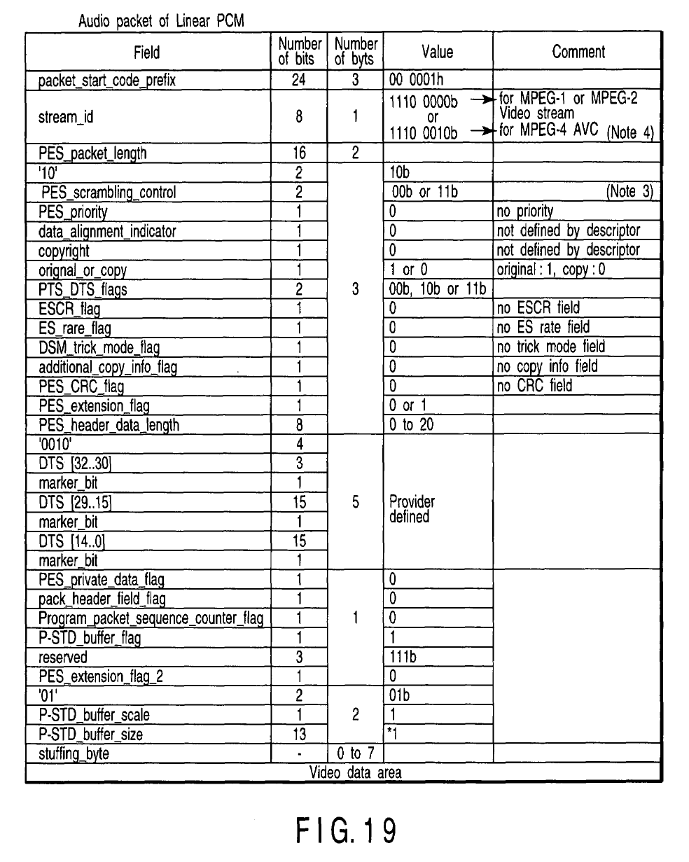

Further, “392” is described in P-STD_buffer_size of the linear PCM of Audio packet shown by *1 in FIG. 19. Likewise, “392” is described also in the P-STD_buffer size of the Sub_picture Packet (in the data pack shown in FIG. 10), though not shown in the drawing (S4).

According to the HD DVD standard, RDI added by GCI is prepared as shown in FIG. 14 (S5).

When the standard of the optical disc detected in the step D2 is DVD (S2—NO), the MPEG encoder 20 outputs an encoded output of MPEG2-PS encoded at a low rate in the DVD-VR mode or HD DVD-VR mode according to (a) or (c) explained hereinbefore. At this time, “10100000b” or “10100001b” is described in sub_stream_id in the contents of the packet header of the linear PCM shown in FIG. 17, according to (1) explained hereinbefore (S6).

Further, “58” is described in P-STD_buffer_size of the linear PCM of Audio packet shown by *1 in FIG. 19. Likewise, “58” is described also in P-STD_buffer_size of Sub_picture Packet (in the data pack shown in FIG. 10), though not shown in the drawing (S7).

According to the HD DVD standard, RDI without GCI is prepared as shown in FIG. 18 (S8).

As for new recording in the HDD 104, the recording process is executed directly from the step S3 or step S6 instead of the detection step shown in the step S2, according to the user's instruction (selection) of HDVR or VR.

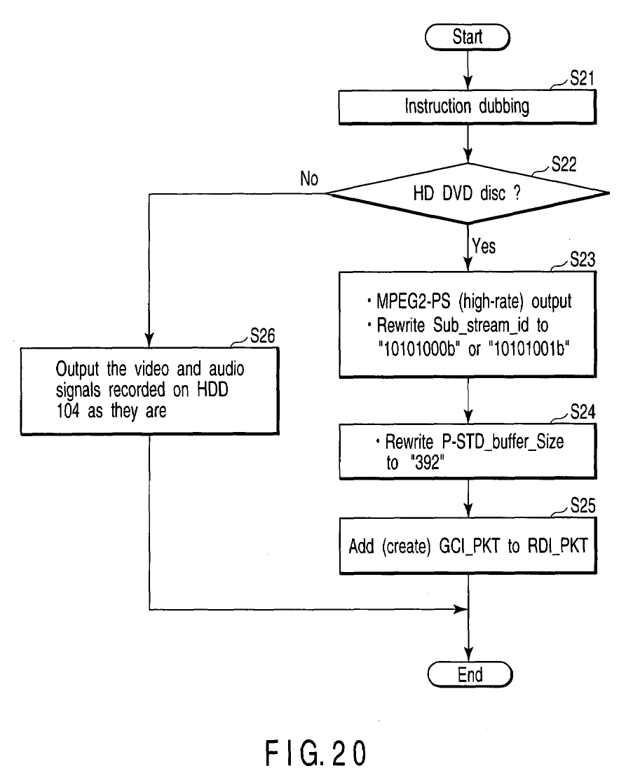

FIG. 20 explains an example of a method of dubbing (moving dubbing-prohibited contents) data recorded in a HD DVD video recording mode (hereinafter called a HDVR mode) or a DVD video recording mode (VR mode), on an inserted medium without re-encoding between HDVR (mode) and VR (mode), in the recording/reproducing apparatus 1 capable of recording the HD DVD disc and DVD disk shown in FIG. 1.

When the user instructs recording (dubbing, or moving in the HDVR mode) on an optical disc set in the disc drive unit 24, that is, the HD DVD standard optical disc 100 or DVD-standard optical disc 102 through a not-shown remote controller (S21), the standard (type) of that optical disc and the conformable format are detected (S22).

When the standard of the optical disc detected in the step S22 is HD DVD (S22—YES), the HDD 104 outputs a high-rate encode output of MPEG2-PS to the disc drive unit 24, in the HD DVD-VR mode according to (b) explained hereinbefore. At this time, the description of sub_stream_id in the contents of the packet header of the linear PCM shown in FIG. 17 is rewritten from “1010000b” or “10100001b” to “10101000b” or “10101001b”, and the data is transferred (dubbed) (S23). Further, the description of P-STD_buffer_size of the linear PCM of Audio packet shown by *1 in FIG. 19 is rewritten from “58” to “392”. Likewise, P-STD_buffer_size of Sub_picture Packet (in the data pack shown in FIG. 10) is rewritten to “392”, though not shown in the drawing (S24). According to the DVD standard, GCI PKT is added to the RDI PKT shown in FIG. 18 (RDI is rewritten to GCI+RDI), and the structure shown in FIG. 14 is given (S25).

When the standard of the optical disk detected in the step S22 is DVD (S22—NO), if the data to be output from the HDD 104 is recordable on a DVD-standard disc, that is, if the data is MPEG2-PS encoded at a low rate in the DVD-VR or HD DVD-VR standard according to (a) or (c) explained hereinbefore, the data is supplied as video and audio signal data (S26).

The video and audio data recorded as above can be dubbed between HDVR and VR without re-encoding (Only moving is possible for dub-prohibited contents).

In most cases where dubbing without re-encoding is allowed between HDVR (mode) and VR (mode), MPEG2-PS data of a copy-free VR title can be copied at a high speed to the optical disc 100 or 102, or copied with a changed rate (at an equal speed), or can only be moved. A title of copy-once contents recorded in the HDD 104 in the HD DVD-VR format is protected against second copy. The copy-protected HDVR title data (including MPEG4-AVC and VC1 in addition to MPEG2-PS) cannot be copied at a high speed or changed rate, but can be moved to the disc 100 or 102 conformable to a predetermined copy management system (CPRM or AACS).

A title of copy-once contents recorded in the HDD 104 as MPEG2-TS is protected against second copy. The copy-protected TS title data cannot be copied at a high speed or changed rate, but can be moved or re-encoded (accompanied by decoding and encoding) to the disc 100 or 102 conformable to a predetermined copy management system (CPRM or AACS).

As explained hereinbefore, by using an embodiment of the invention, a Stream conformable to both HD DVD VR and DVD VR formats can be recorded in a recording/reproducing apparatus capable of recording on discs of both HD DVD VR and DVD VR formats, and the format can be converted without re-encoding when dubbing (or moving).

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

What is claimed is:

1. A video/audio signal recording method comprising:
discriminating a first recording medium configured to record video and audio signals according to a first standard, and a second recording medium configured to record video and audio signals according to a second standard with a recordable information amount increased to higher than the first standard;
recording the video and audio signals on the second recording medium according to the second standard, or the first standard configured to be transferred or copied to the first recording medium; and
recording the video and audio signals on the first recording medium according to the first standard.

2. The video/audio signal recording method according to claim 1, wherein the video and audio signals recorded on the second recording medium according to the first standard configured to be transferred or copied to the first recording medium are configured to be transferred or copied to the first recording medium without decoding and re-encoding.

3. The video/audio signal recording method according to claim 2, wherein the video and audio signals recorded according to the first standard configured to be transferred or copied to the first recording medium are different from the video and audio signals recorded according to the first standard, in sub_stream_id of Audio Packet in a data structure.

4. The video/audio signal recording method according to claim 3, wherein when the video and audio signals recorded according to the first standard configured to be transferred or copied to the first recording medium are transferred or copied from the second recording medium to the first recording medium, the video and audio signals recorded according to the first standard are rewritten in sub_stream_id of the Audio Packet.

5. The video/audio signal recording method according to claim 3, wherein when the video and audio signals recorded according to the first standard configured to be transferred or copied to the first recording medium are transferred or copied from the second recording medium to the first recording medium, the video and audio signals recorded according to the first standard are rewritten in values of P-STD_buffer_size of the Audio Packet and Sub-picture Packet.

6. The video/audio signal recording method according to claim 3, wherein when the video and audio signals recorded according to the first standard configured to be transferred or copied to the first recording medium are transferred or copied from the second recording medium to the first recording medium, the video and audio signals recorded according to the first standard are deleted GCI from RDI added by GCI in a data structure.

7. The video/audio signal recording method according to claim 2, wherein the video and audio signals recorded according to the first standard configured to be transferred or copied to the first recording medium are different from the video and audio signals recorded according to the first standard in values of P-STD_buffer_size of Audio Packet and Sub-picture Packet in a data structure.

8. The video/audio signal recording method according to claim 2, wherein RDI Pack added by GCI is inserted into the video and audio signals recorded according to the first standard configured to be transferred or copied to the first recording medium, and a single RDI pack is inserted into the video and audio signals recorded according to the first standard.

9. A recording/reproducing apparatus comprising:
a disc drive which records video and audio signals on a first optical disc of a first standard configured to record video and audio signals according to a first standard, and a second optical disc of a second standard configured to record video and audio signals according to a second standard with recordable information amount increased to higher than the first standard, according to standard of each optical disc;
a recording unit which records the video and audio signals in any one of the second standard, first standard, or first standard in the second standard configured to be transferred or copied to the first recording medium; and
a data control unit which transfers or moves video and audio signals recorded in the recording unit in one of the first standard and first standard in the second standard configured to be transferred or copied to the first recording medium, to an optical disc of the first standard through the disc drive, and transfers or moves video and audio signals recorded in any one of the first standard, first standard in the second standard configured to be transferred or copied to the first recording medium, and second standard, to an optical disc of the second standard through the disc drive.

10. The recording/reproducing apparatus according to claim 9, further comprising:
a detection unit which detects that the video and audio signals recorded to be capable of being transferred or moved to the first recording medium configured to record the first standard exist on the second recording medium configured to record the second standard, from specific information of data structure, wherein
the data control unit transfers or moves the video and audio signals recorded to be capable of being transferred or moved to the first recording medium configured to record the first standard, to the first recording medium without re-encoding, when the detection unit detects that the video and audio signals recorded to be capable of being transferred or moved to the first recording medium exist.
